(19) United States
(12) Patent Application Publication
(10) Pub. No.: US 2006/0146190 A1
(43) Pub. Date: Jul. 6, 2006

(54) Screen aspect-ratio conversion apparatus and method

(76) Inventors: Won-seok Ahn, Seoul (KR); Young-ho Lee, Yongin-si (KR); Jae-oh Lee, Suwon-si (KR)

Correspondence Address: STANZIONE & KIM, LLP, 919 18TH STREET, N.W., SUITE 440, WASHINGTON, DC, 20006, US

(21) Appl. No.: 11/288,394

(22) Filed: Nov. 29, 2005

(30) Foreign Application Priority Data
Dec. 30, 2004 (KR) 2004-116306

(51) Int. Cl. H04N 7/01; H04N 11/20

(52) U.S. Cl. 348/458; 348/441

(57) ABSTRACT

An aspect-ratio conversion apparatus and a method. The aspect-ratio conversion apparatus to convert an aspect-ratio includes a letterbox border detection unit to detect letterbox border values of a current input image, an adaptive output unit to determine whether the detected letterbox border values are valid, and to output the detected letterbox border values if the detected letterbox values are valid, and a scaling unit to adjust a size of a substantial image area to fit a size of a screen of a display device based on the letterbox border values received from the adaptive output unit.

### CROSS-REFERENCE TO RELATED APPLICATIONS

This application claims the benefit under 35 U.S.C. § 119 from Korean Patent Application No. 2004-116306, filed on Dec. 30, 2004 in Korean Intellectual Property Office, the entire contents of which are incorporated herein by reference.

### BACKGROUND OF THE INVENTION

1. Field of the Invention

The present general inventive concept relates to screen aspect-ratio conversion apparatus and method, and more particularly, to apparatus and method of preventing frequent conversion of an aspect-ratio that occurs due to frequent changes of detected letterbox borders when automatically detecting the letterbox borders, and adaptively converting an image aspect-ratio.

2. Description of the Related Art

In general, a television set as one of image display devices enables users to select a vertical aspect-ratio of an input image by diversely changing pixel ratios in a vertical direction regardless of an aspect-ratio of the input image so as to watch programs on a screen having a selected vertical aspect ratio. However, most conventional television sets have the screen aspect-ratio of 4:3 in a display format of the screen of a cathode ray tube (CRT) type image display device. Likewise, most image (signal) sources have the 4:3 screen aspect-ratio. That is, all the image sources do not have the 4:3 screen aspect ratio. For example, movies (movie image signal or movie source) are converted from a film format to a videotape format in order to be reproduced or sent as a television signal. Such movie sources need to be converted to have the 4:3 screen aspect-ratio suitable for most television sets, when being converted into the video format. The movie sources include wide-screen image sources having the display format of 16:9 screen aspect-ratio, for example.

Devices, such as flying spot telecine, are used to convert the movie sources into the videotape format. The flying spot telecine has a window or a frame of 4:3 screen aspect ratio, and, in general, an operator of the flying spot telecine moves the window to the left and right, cutting off the left and right sides of movie images as much as needed while keeping track of an action in the movie, since a width of the movie images is wider than a width of the screen of the 4:3 aspect ratio when a height of the movie images fits the screen of the 4:3 aspect ratio. Thus, if the movie source of 16:9 screen aspect ratio is converted into an image signal having the 4:3 aspect ratio, a portion of the image signal is not shown because the portion has been cut off from the movie images.

If wide-screen images of 16:9 aspect-ratio is scaled down to an image width to fit in the left and right borders of the screen having a 4:3 aspect ratio, a height of the wide-screen images needs to be more scaled down. As a result, the wide-screen images are completely displayed on the screen of 4:3 aspect ratio, but a portion corresponding to a top and a bottom of the screen of 4:3 aspect ratio may not be displayed. Therefore, dark bars are displayed on the top and bottom of the wide-screen images displayed on the screen of 4:3 aspect-ratio to avoid a spurious signal that can be generated in the not-shown portion. Such images with dark bars are generally referred to as letterbox-format images.

That is, the letterbox-format images have blank spaces on the top and bottom of an area on which the images are displayed, and the blank spaces (‘letterbox regions’) correspond to non-signal regions. Here, if there are the letterbox regions in an input image, the image is not displayed on the letterbox regions, but displayed on a substantial image region other than the letterbox regions.

In a conventional auto-wide function implemented in an image display device, an image size in the substantial image region other than the letterbox regions is switched to another image size suitable for the screen of the image display device. The auto-wide function for switching the image size detects the input image aspect ratio based on the letterbox borders separating the letterbox regions from the substantial image region.

Conventionally, the letterbox borders are detected by comparing consecutive lines of the input image. However, a conventional method for detecting the letterbox borders frequently switches image sizes during image when computer graphics interface (CGI), such as captions or logos, exists in the letterbox regions, and the conventional method can not exactly detect the border values of the letterbox regions due a failure of detecting edges at the substantial borders of the letterbox regions including the captions or logos. Thus, frequent changes of the image size and the aspect-ratio of displayed images causes a problem in that television viewers can feel visual fatigue.

### SUMMARY OF THE INVENTION

The present general inventive concept provides an aspect-ratio conversion apparatus and method having an auto-wide function to provide viewers with more convenience and stability using active and inactive regions and determining as valid detection values only letterbox border values belonging to the active regions.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an aspect-ratio conversion apparatus, comprising a letterbox border detection unit to detect letterbox border values of a current input image, an adaptive output unit to determine whether the detected letterbox border values are valid, and to output the detected letterbox border values if the detected letterbox values are valid, and a scaling unit to adjust a size of a substantial image area to fit a size of a screen of a display device based on the letterbox border values received from the adaptive output unit.

The letterbox border values may include a letterbox upper-border value and a letterbox lower-border value.

The adaptive output unit may include a threshold value-setting unit to set threshold values th_a, th_b, th1, th2, th3, and th4 corresponding to a size of the current input image, an inactive region-setting unit to set a first inactive region and a second inactive region in a first active region and a second active region, respectively, located above a previous letterbox upper-border value and below a previous letterbox lower-border value, based on the letterbox upper-border and lower-border values detected from a previous image and the threshold values th_a and th_b provided from the threshold value-setting unit, and a comparison unit to determine whether the letterbox upper-border value detected from the current image belongs to the first active region and whether the letterbox lower-border value detected from the current image belongs to the second active region, and to determine whether the letterbox border values detected from the current image are valid.

Widths of the first and second inactive regions may be determined by the threshold values th_a and th_b.

The inactive region-setting unit may control an image center portion of the current input image to which a substantial signal is input to overlap the first and second inactive regions.

A width of the first active region may be determined by the first and second threshold values th1 and th2, and a width of the second active region may be determined by the third and fourth threshold values th3 and th4.

The first inactive region may be included in the first active region, and the second inactive region may be included in the second active region.

If the letterbox upper-border value detected from the current image belongs to the first active region, the comparison unit may determine the letterbox upper-border value as a valid detection value.

If the letterbox lower-border value detected from the current image belongs to the second active region, the comparison unit may determine the letterbox lower-border value as a valid detection unit.

The adaptive output unit may further include a decision unit to output a previous letterbox border value of the previous image to the scaling unit if a difference between the letterbox upper-border value and the letterbox lower-border value exceeds a predetermined threshold value, and either the letterbox upper-border value or the letterbox lower-border value is not valid.

The decision unit may be located between the comparison unit and the scaling unit.

The foregoing and/or other aspects of the present general inventive concept may also be achieved by providing an aspect-ratio conversion method, comprising detecting letterbox border values of a current input image, the detected letterbox values are whether the detected letterbox border values are valid, and outputting the letterbox border values if the detected letterbox values are valid, and adjusting a size of a substantial image area to fit a size of a screen of a display device based on the output letterbox border values.

The letterbox border values may include a letterbox upper-border value and a letterbox lower-border value.

The outputting of the letterbox border values may include setting threshold values th_a, th_b, th1, th2, th3, and th4 corresponding to a size of the current input image, setting a first inactive region and a second inactive region in a first active region and a second active region, respectively, located above a previous letterbox upper-border value and below a previous letterbox lower-border value, based on the previous letterbox upper-border and lower-border values detected from a previous image and the threshold values th_a and th_b provided in the setting of the threshold values and determining whether the letterbox upper-border value detected from the current image belongs to the first active region and whether the letterbox lower-border value detected from the current image belongs to the second active region, and determining whether the letterbox upper-border and lower-border values detected from the current image are valid.

Widths of the first and second inactive regions may be determined by the threshold values th_a and th_b.

An image center portion of the current input image to which a substantial signal is input may overlap the first and second inactive regions.

A width of the first active region may be determined by the first and second threshold values th1 and th2, and a width of the second active region may be determined by the third and fourth threshold values th3 and th4.

The first inactive region may be included in the first active region, and the second inactive region may be included in the second active region.

If the letterbox upper-border value detected from the current image belongs to the first active region, the determining of the letterbox upper-border and lower-border values detected from the current image are valid may comprise determining the letterbox upper-border value as a valid detection value.

If the letterbox lower-border value detected from the current image belongs to the second active region, the determining of the letterbox upper-border and lower-border values detected from the current image are valid may comprise determining the letterbox lower-border value as a valid detection value.

The foregoing and/or other aspects of the present general inventive concept may also be achieved by providing an apparatus to convert an input image having a first aspect-ratio to an image to fit a screen having a second aspect-ratio, the apparatus comprising a letterbox border detection unit to detect a first letterbox border and a second letterbox border of an input image signal having a first aspect-ratio displayed on a screen having a second aspect-ratio, an adaptive output unit to selectively output one of the first letterbox border and a previous first letterbox border according to the first and second letterbox borders and corresponding reference values, and to selectively output one of the second letterbox borders and a previous second letterbox borders according to the first and second letterbox borders and corresponding reference values, and an image conversion unit to calculate the first aspect-ratio of the input image signal using the received first and second letterbox borders, and to convert the input image signal into another image fitting the screen having the second aspect ratio.

The foregoing and/or other aspects of the present general inventive concept may also be achieved by providing an adaptive output unit used in an apparatus to convert input images having an aspect-ratio calculated based on letterbox borders into images having a predetermined aspect-ratio, the adaptive output unit comprising a border regions setting unit to define a displayed image area having the predetermined aspect ratio, a first inactive region having a first inactive region width inside the displayed image area and a second inactive region having a second inactive region width inside the displayed image area, and a decision unit to receive a first detected letterbox border and a second detected letterbox border of an input image fitting one of width or height of the displayed image area, and to output the first detected letterbox border if the first detected letterbox border is outside of the first inactive region, and to output the second detected letterbox border if the second detected letterbox border is outside of the second inactive region.

The foregoing and/or other aspects of the present general inventive concept may also be achieved by providing a method of converting an input image having a first aspect-ratio to an image to fit a screen having a second aspect-ratio, the method comprising detecting a first letterbox border and a second letterbox border of an input image signal having a first aspect-ratio displayed on a screen having a second aspect-ratio, selectively outputting one of the first letterbox border and a previous first letterbox border according to the first and second letterbox borders and corresponding reference values, and to selectively output one of the second letterbox borders and a previous second letterbox borders according to the first and second letterbox borders and corresponding reference values, and calculating the first aspect-ratio of the input image signal using the received first and second letterbox borders, and converting the input image signal into another image fitting the screen having the second aspect ratio.

The foregoing and/or other aspects of the present general inventive concept may also be achieved by providing a method of selectively outputting detected letterbox borders, comprising defining a displayed image area having a predetermined aspect ratio, a first inactive region having a first inactive region width inside the displayed image area and a second inactive region having a second inactive region width inside the displayed image area, detecting a first detected letterbox border and a second detected letterbox border of an input image fitting one of width or height of the displayed image area, and outputting the first detected letterbox border if the first detected letterbox border has a value not belonging to the first inactive region, and the second detected letterbox border if the second detected letterbox border has a value not belonging to the second inactive region.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an apparatus to convert an aspect-ratio according to an embodiment of the present general inventive concept;

FIG. 2 is a block diagram illustrating an adaptive output unit of the apparatus of FIG. 1;

FIGS. 3A and 3B are views illustrating active and inactive regions that are used to determine whether letterbox border values are valid;

FIG. 4 is a flow chart illustrating a method of converting an image aspect-ratio according to an embodiment of the present general inventive concept; and

FIG. 5 is a view exemplarily illustrating a conversion state from an image with letterbox regions to an image without letterbox regions.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

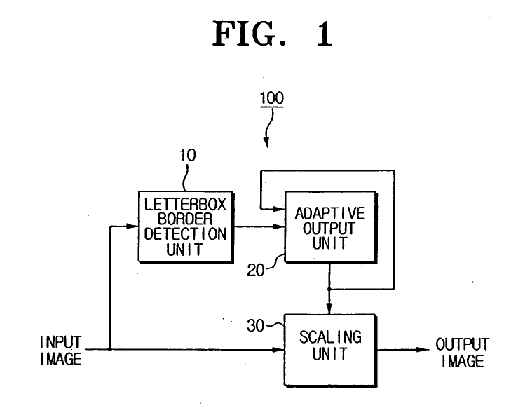

FIG. 1 is a block diagram illustrating an apparatus 100 to convert an aspect-ratio according to an embodiment of the present general inventive concept. In FIG. 1, the apparatus 100 has a letterbox border detection unit 10, an adaptive output unit 20, and a scaling unit 30.

The letterbox border detection unit 10 detects one or more letterbox border values of one or more letterbox regions from a current input image. The current image may include an image center portion and the letterbox regions. The one or more letterbox border values represent values between the image center portion and the respective letterbox regions.

The adaptive output unit 20 determines whether the detected letterbox border values of the current input image are valid. The adaptive output unit 20 outputs the letterbox border values of the current input image if the detected letterbox border values are valid, and outputs prior letterbox border values of the previous image if the detected letterbox values are not valid. When the detected letterbox border value belongs to a value of an active region, it is determined that the detected letterbox value is valid. When the detected letterbox border value does not belong to the value of the active region, but a value of an inactive region, it is determined that the detected letterbox border value is not valid. The active region represents a region including a letterbox. The inactive region represents a region which does not include an object image. For example, when a caption or a logo exists in the letterbox, and the letterbox border values correspond to a border between the image center portion and the letterbox relates to the value of the active region, the letterbox value is determined to be valid.

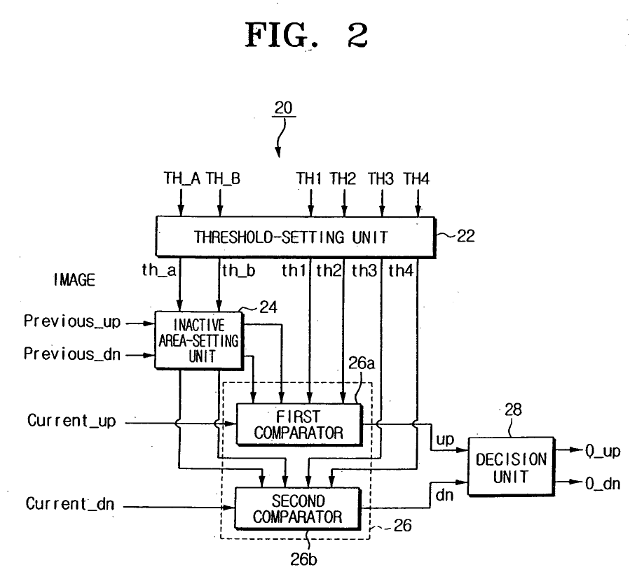

FIG. 2 is a block diagram illustrating the adaptive output unit 20 of the apparatus 100 of FIG. 1. In FIG. 2, the adaptive output unit 20 has a threshold-setting unit 22, an inactive area-setting unit 24, and a comparison unit 26. Further, the adaptive output unit 20 may include a decision unit 28. Although the decision unit 28 may be an optional component of the adaptive output unit 20, the decision unit 28 may further verify whether output values of the comparison unit 26 are valid. The decision unit 28 may confirm that the detected letterbox border values is valid if the difference between the letterbox border values is substantially equal to a predetermined value representing a width of the current input image. If the difference is not substantially equal to the predetermined value, the decision unit 28 may render the detected letterbox border values as invalid. Furthermore, if only one of the detected letterbox border values is valid, the decision unit 28 may render the detected letterbox border values as invalid.

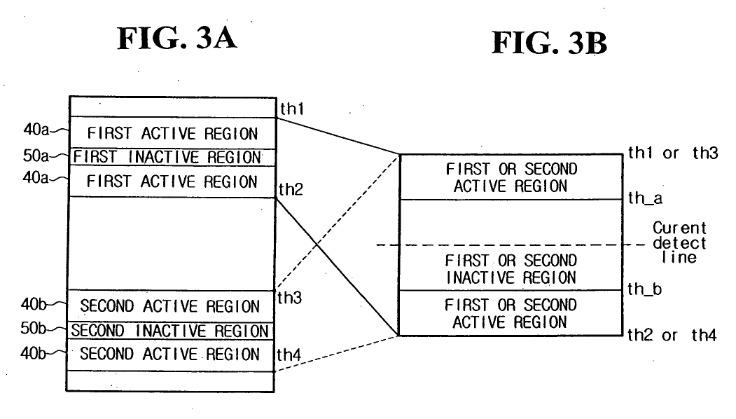

The threshold-setting unit 22 sets input parameters TH_A, TH_B, TH1, TH2, TH3, and TH4 to optimized threshold values th_a, th_b, th1, th2, th3, and th4 depending on a size and an aspect-ratio of one or more input images. The optimized threshold values th_a and th_b are used to determine widths of one or more inactive regions and first, second, third and fourth threshold values th1, th2, th3, and th4 are used to determine widths of one or more active regions. FIGS. 3A and 3B are views illustrating the active and inactive regions that are used to determine whether the detected letterbox border values are valid. In FIG. 3A, the active regions are a first active region 40a and a second active region 40b, and the inactive regions are a first inactive region 50a and a second inactive region 50b. The first inactive region 50a may be between the first active regions 40a, and the second inactive region 50b may be between second active regions 40b. A width of the first active region 40a is determined by the first threshold value th1 and the second threshold value th2, and a width of the second active region 40b is determined by the third threshold value th3 and the fourth threshold value th4. The width represents a dimension of each region in a direction along which, the active region, the inactive region, and the image center portion are disposed on a screen of a display device.

Further, the threshold values th_a and th_b determine existence of the first inactive region 50a and the second inactive region 50b, respectively, disposed between the first and second active regions 40a and 40b.

The inactive area-setting unit 24 sets the first and second inactive regions 50a and 50b respectively inside the first and second active regions 40a and 40b located above or below prior letterbox border values, based on prior letterbox border values detected from a previous image and the threshold values th_a and th_b provided from the threshold-setting unit 22.

The comparison unit 26 has first and second comparators 26a and 26b. The first comparator 26a decides whether a letterbox upper-border value detected from the current image belongs to the first active region 40a, and the second comparator 26b decides whether a letterbox lower-border value detected from the current image belongs to the second active region 40b. The comparison unit 26 determines if the letterbox border values detected from the current input image are valid according to results of the comparators 26a and 26b. A detected letterbox border value is valid if the detected letterbox border value corresponds to a value of an active region. If the detected letterbox border value does not correspond to the value of the active region, but a value of the inactive region, the detected letterbox value is not valid.

That is, if the letterbox upper-border value detected from the current image belongs to the first active region 40a, the comparison unit 26 decides the detected letterbox upper-border value of the current input image is a valid detection value, and sends the detected letterbox upper-border value of the current input image to the scaling unit 30. If the letterbox lower-border value detected from the current input image belongs to the second active region 40b, the comparison unit 26 decides the detected letterbox lower-border value of the current input image is a valid detection value, and sends the detected letterbox lower-border value of the current input image to the scaling unit 30.

Further, as shown in FIG. 3B, if the detected letterbox upper-border value of the current input image belongs to the first inactive region 50a, the comparison unit 26 decides that the current detected letterbox upper-border value is not the valid detection value. If the detected letterbox lower-border value of the current input image belongs to the second inactive region 50b, the comparison unit 26 decides that the current detected letterbox lower-border value is not the valid detection value. As described above, if either the detected letterbox upper-border value or the detected letterbox lower-border of the current input image is not the valid detection value, the comparison unit 26 outputs to the decision unit 28 the letterbox upper-border value or the letterbox lower-border value, measured from a previous image.

The scaling unit 30 adjusts a size of an image so that a substantial image area (image center portion) except for the letterbox regions fits a size of the screen of the display device, based on the letterbox border values provided from the selective output unit 20.

As shown in FIG. 2, the selective output unit 20 can further include the decision unit 28 between the comparison unit 26 and the scaling unit 30 in order to further check an output value of the comparison unit 26.

As described above, if the decision unit 28 is included in the adaptive output unit 20, the decision unit 28 decides a final output depending on positions of the letterbox upper-border value and the letterbox lower-border value that are received from the comparison unit 26.

That is, if a difference between the letterbox upper-border value and the letterbox lower-border value exceeds a predetermined threshold value or either of the letterbox upper-border value or the letterbox lower-border value is not valid, the decision unit 28 invalidates changes to the letterbox border value, and outputs the letterbox border values of the previous image to the scaling unit 30.

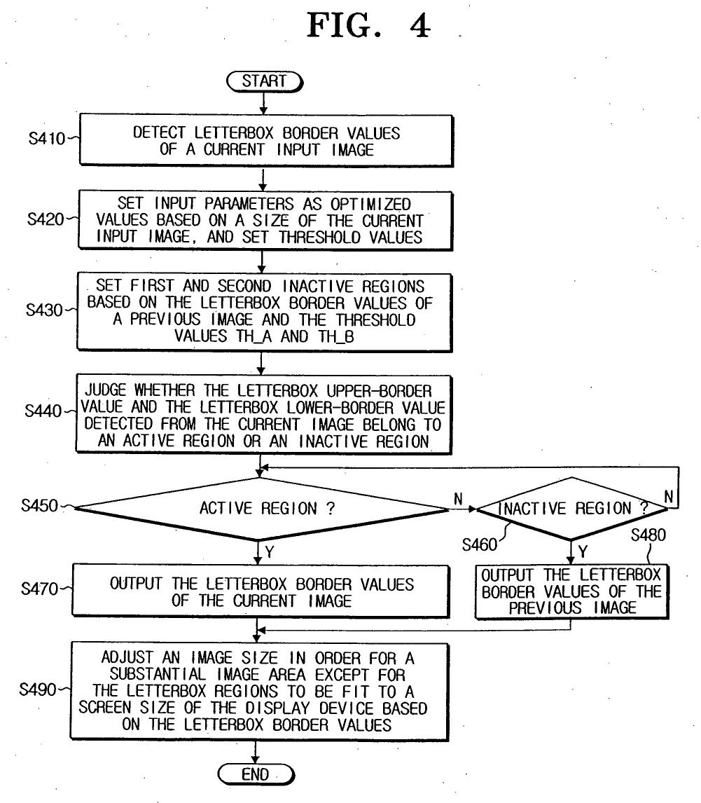

FIG. 4 is a flow chart illustrating a method of converting an aspect-ratio according to an embodiment of the present general inventive concept. Referring to FIGS. 1, 2, and 4, first, the letterbox border detection unit 10 detects one or more letterbox border values of a current input image (operation S410).

Hereinbellow, a method of detecting border values of letterbox regions according to an embodiment of the present general inventive concept is described. An average pixel value is calculated over a dark bar portion, and, if a difference between the calculated average pixel value and a pixel value of a current image pixel is smaller than a predetermined threshold value T1, the method detects the current image pixel as a dark pixel. Here, if the detected dark pixels appear consecutively the detected dark pixels form a length of the dark pixels defined as ‘black run-length (BRL)’.

If a value of BRL is larger than a predetermined second threshold value T2, that is, if the length of the consecutive dark pixels forming a black bar of a current line is over a certain length, the line of an input image is detected as included in a letterbox region. Next, the lines detected as included in letterbox regions are used to determine the letterbox border values. That is, if a line in same position of an input image is detected as one of the letterbox borders in more than a predetermined number of times, the position of the line is finally detected as the letterbox border of the input image and an inactive region is positioned by the inactive area-setting unit 24 accordingly.

The above-described method of detecting the letterbox regions is applied to the present embodiment, but other general methods can be used to detect the letterbox borders of the letterbox regions.

If a letterbox border value of a current input image is detected in the operation S410, the threshold-setting unit 22 sets the input parameters TH_A, TH_B, TH1, TH2, TH3, and TH4 to threshold values depending on the input image (operation S420).

Here, the threshold-setting unit 22 may set the input parameters to pre-set values corresponding to a size of the input image and an input image aspect-ratio or through values calculated proportional to the size of the input image.

Here, the optimized threshold values th_a and th_b are used to determine the widths of the inactive regions and the first to the fourth threshold values th1, th2, th3, and th4 are used to determine the widths of the active regions.

The inactive area-setting unit 24 sets the first and second inactive regions 50a and 50b in the first and second active regions 40a and 40b located above and below a previous letterbox border value, based on letterbox border values detected from a previous image and the predetermined threshold values th_a and th_b provided from the threshold-setting unit 22 (operation S430). In here, the inactive area-setting unit 24 controls the image center portion in which the substantial image signal area is input to be set to overlap the inactive regions. As stated above, the inactive regions 40a and 40b are set broad in width as to overlap an image center portion in which the substantial image signal is input, to stably implement an auto-wide function by mitigating changes to an image center portion since it is highly possible for a dark-image signal to be input to a center portion of an image.

Next, the first comparator 26a of the comparison unit 26 determines whether the letterbox upper-border value detected in the current input image belongs to the first active region 40a, and the second comparator 26b determines whether the letterbox lower-border value detected in the current input image belongs to the second active region (operation S440).

As a result of the determination, if the letterbox border values detected in the current input image belong to one of the active regions (operation S450), the comparison unit 26 determines the detected letterbox border values of the current image as valid detection values, and outputs the letterbox border values of the current input image to the decision unit 28 (operation S470).

Further, if the letterbox border values detected in the current input image belong to one of the inactive regions, the detected letterbox border values are determined to be not valid detection values, and the comparison unit 26 outputs the letterbox border values measured in a previous image to the decision unit 28 (operation S480).

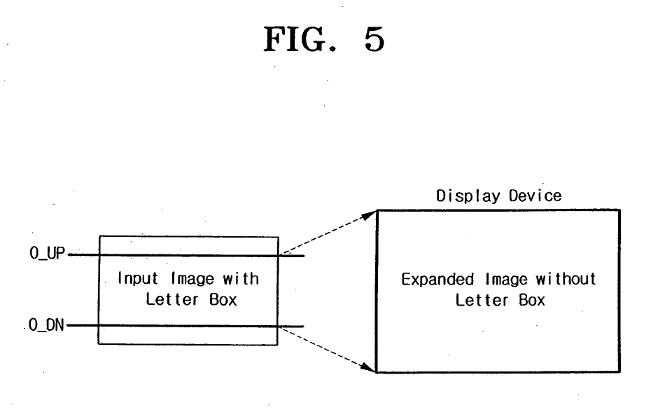

FIG. 5 is a view exemplarily illustrates a conversion by the scaling unit from an image with letterbox regions to an image without letterbox regions. In FIG. 5, the scaling unit 30 adjusts the substantial image area by scaling and expanding the substantial image area and changing the aspect ratio to fit a size of the screen of a display device. The scaling unit performs the conversion based on the letterbox border values (O_UP and O_DN) provided from the adaptive output unit 20 (operation S490), so that the image with letterbox regions is adjusted to fit the size of the screen of the display device and converted to the image without letterbox regions.

As stated above, the present general inventive concept determines as the valid detection values only the letterbox border values inside the active regions, thereby providing a more stable auto-wide function. That is, if the detected letterbox borders of a current image vary slightly being within the inactive regions, previous letterbox border values are provided to the scaling unit, therefore maintaining letterbox borders positions and aspect-ratio conversion of the previous image when applying the auto-wide function. When the detected letterbox borders of the current image vary significantly being within the active regions, the detected letterbox border values are provided to the scaling unit, therefore the letterbox borders positions and the aspect-ratio conversion are adjusted when applying the auto-wide function.

As aforementioned, the present general inventive concept has an advantage of providing a more stable auto-wide function by preventing frequent changes to screen aspect ratios occurring due to changes to detected letterbox borders, since the present general inventive concept determines as valid detection values only the letterbox border values belonging to the active regions when detecting letterbox borders from an input image and adaptively changing image aspect ratios.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An aspect-ratio conversion apparatus, comprising:
a letterbox border detection unit to detect letterbox border values of a current input image;
an adaptive output unit to determine whether the detected letterbox border values are valid, and to output the detected letterbox border values if the detected letterbox values are valid; and
a scaling unit to adjust a size of a substantial image area to fit a size of a screen of a display device based on the letterbox border values received from the adaptive output unit.

2. The aspect-ratio conversion apparatus as claimed in claim 1, wherein the letterbox border values comprise a letterbox upper-border value and a letterbox lower-border value.

3. The aspect-ratio conversion apparatus as claimed in claim 2, wherein the letterbox border detection unit detects previous letterbox upper-border and lower-border values of a previous image, and the adaptive output unit comprises:
a threshold value-setting unit to set first and second inactive width threshold values and first, second, third and fourth threshold values corresponding to a size of the current input image;
an inactive region-setting unit to set a first inactive region including the previous letterbox upper-border value and a second inactive region including the previous letterbox lower-border value in a first active region and a second active region, respectively based on the first and second inactive width threshold values provided from the threshold value-setting unit; and
a comparison unit to determine whether the letterbox upper-border value belongs to the first active region and whether the letterbox lower-border value belongs to the second active region, and to determine whether the letterbox border values detected from the current input image are valid.

4. The aspect-ratio conversion apparatus as claimed in claim 3, wherein widths of the first and second inactive regions are determined by the first and second inactive width threshold values.

5. The aspect-ratio conversion apparatus as claimed in claim 3, wherein the inactive region-setting unit controls a center portion where the current input image is displayed to overlap the first and second inactive regions.

6. The aspect-ratio conversion apparatus as claimed in claim 3, wherein a width of the first active region is determined by the first and second threshold values, and a width of the second active region is determined by the third and fourth threshold values.

7. The aspect-ratio conversion apparatus as claimed in claim 3, wherein the first inactive region is included in the first active region, and the second inactive region is included in the second active region.

8. The aspect-ratio conversion apparatus as claimed in claim 3, wherein, if the letterbox upper-border value is inside the first active region, the comparison unit determines the letterbox upper-border value as a valid detection value.

9. The aspect-ratio conversion apparatus as claimed in claim 3, wherein, if the letterbox lower-border value is inside the second active region, the comparison unit determines the letterbox lower-border value as a valid detection value.

10. The aspect-ratio conversion apparatus as claimed in claim 3, wherein the adaptive output unit further comprises a decision unit to output the letterbox upper-border value and the letterbox lower-border value of the previous image to the scaling unit, if a difference between the detected letterbox upper-border value and the detected letterbox lower-border value exceeds a predetermined threshold value, and either the letterbox upper-border value or the letterbox lower-border value is not valid.

11. The aspect-ratio conversion apparatus as claimed in claim 10, wherein the decision unit is located between the comparison unit and the scaling unit.

12. An aspect-ratio conversion method, comprising:
detecting letterbox border values of a current input image;
determining whether the letterbox border values are valid, and outputting the letterbox border values if determined valid; and
adjusting a size of a substantial image area to fit a size of a screen of a display device based on the output letterbox border values.

13. The aspect-ratio conversion method as claimed in claim 12, wherein the letterbox border values comprise a letterbox upper-border value and a letterbox lower-border value.

14. The aspect-ratio conversion method as claimed in claim 12, wherein the outputting of the letterbox border values includes:
detecting previous letterbox upper-border and lower-border values of a previous image;
setting first and second inactive width threshold values and first, second, third and fourth threshold values corresponding to a size of the current input image;
setting first and second inactive regions in first and second active regions respectively wherein the first inactive region includes the previous letterbox upper-border value and wherein the first inactive region includes the previous letterbox lower-border value, based on the inactive width threshold values; and
determining whether the letterbox upper-border value of the current input-image belongs to the first active region and whether the letterbox lower-border value of the current input image belongs to the second active region, and for determining whether the letterbox upper-border and lower-border values detected from the current input image are valid.

15. The aspect-ratio conversion method as claimed in claim 14, wherein widths of the first and second inactive regions are determined by the inactive width threshold values.

16. The aspect-ratio conversion method as claimed in claim 14, wherein the setting of the first inactive region and the second inactive region controls a center portion of the current input image to overlap the first and second inactive regions.

17. The aspect-ratio conversion method as claimed in claim 14, wherein a width of the first active region is determined by the first and second threshold values, and a width of the second active region is determined by the third and fourth threshold values.

18. The aspect-ratio conversion method as claimed in claim 14, wherein the first inactive region is included in the first active region, and the second inactive region is included in the second active region.

19. The aspect-ratio conversion method as claimed in claim 14, wherein, if the letterbox upper-border value belongs to the first active region, the determining of whether the letterbox upper-border and lower-border values of the current input image are valid determines the letterbox upper-border value as a valid detection value.

20. The aspect-ratio conversion method as claimed in claim 14, wherein, if the letterbox lower-border value belongs to the second active region, the determining of whether the letterbox upper-border and lower-border values detected from the current input image are valid determines the letterbox lower-border value as a valid detection value.

21. An apparatus to convert an input image having a first aspect-ratio to an image to fit a screen having a second aspect-ratio, the apparatus comprising:
a letterbox border detection unit to detect a first letterbox border value and a second letterbox border value of an input image signal having a first aspect-ratio displayed on a screen having a second aspect-ratio;
an adaptive output unit to selectively output one of the first letterbox border value and a previous first letterbox border value, and one of the second letterbox border value and a previous second letterbox border value, according to the first and second letterbox border values and corresponding reference values; and
an image conversion unit to calculate the first aspect-ratio of the input image signal using the received first and second letterbox border values, and to convert the input image signal into another image fitting the screen having the second aspect ratio.

22. The apparatus of claim 21, wherein:
the adaptive output unit stores the previous first and second letterbox border values from a previous input image signal;
the adaptive output unit outputs the previous first letterbox border value if the detected first letterbox border value has a value that belongs to a first inactive region;
the adaptive output unit outputs the detected first letterbox border value if the detected first letterbox border value has a value belonging to a first active region and not belonging to the first inactive region;
the adaptive output unit outputs the previous second letterbox border value if the detected second letterbox border value has a value belonging to a second inactive region; and
the adaptive output unit outputs the detected second letterbox border value if the detected second letterbox border value has a value belonging to a second active region not belonging to the second inactive region.

23. The apparatus of claim 22, wherein the adaptive output unit determines the first and second inactive regions to include the previous first and second letterbox border values respectively, and to have a first predetermined width and a second predetermined width.

24. The apparatus of claim 21, wherein the adaptive output unit doe not output the detected first and second letterbox border values unless the distance between the detected first and second letterbox border values is substantially equal with a predetermined image width.

25. The apparatus of claim 21, wherein the adaptive output unit does not output the detected first and second letterbox border values unless both the detected first and second letterbox border values are outside the first and second inactive regions respectively.

26. An adaptive output unit used in an apparatus to convert input images having an aspect-ratio calculated based on letterbox border values into images having a predetermined aspect-ratio, the adaptive output unit comprising:
a border regions setting unit to define a displayed image area having the predetermined aspect ratio, a first inactive region having a first inactive region width inside the displayed image area and a second inactive region having a second inactive region width inside the displayed image area; and
a decision unit to receive a first detected letterbox border value and a second detected letterbox border value of an input image fitting one of width or height of the displayed image area, and to output the first detected letterbox border value if the first detected letterbox border value is outside of the first inactive region, and to output the second detected letterbox border value if the second detected letterbox border value is outside of the second inactive region.

27. A method of converting an input image having a first aspect-ratio to an image to fit a screen having a second aspect-ratio, the method comprising:
detecting a first letterbox border value and a second letterbox border value of an input image signal having a first aspect-ratio displayed on a screen having a second aspect-ratio;
selectively outputting one of the first letterbox border value and a previous first letterbox border value according to the first and second letterbox border values and corresponding reference values, and to selectively output one of the second letterbox border values and a previous second letterbox border values according to the first and second letterbox border values and corresponding reference values; and
calculating the first aspect-ratio of the input image signal using the received first and second letterbox border values, and converting the input image signal into another image fitting the screen having the second aspect ratio.

28. A method of selectively outputting detected letterbox border values, comprising:
defining a displayed image area having a predetermined aspect ratio, a first inactive region having a first inactive region width inside the displayed image area and a second inactive region having a second inactive region width inside the displayed image area;
detecting first and second letterbox border values of an input image fitting one of width or height of the displayed image area; and
outputting the first detected letterbox border value if the first detected letterbox border value has a value not belonging to the first inactive region, and the second detected letterbox border value if the second inactive region.
